(19) United States
(12) Patent Application Publication
(10) Pub. No.: US 2025/0074051 A1
(43) Pub. Date: Mar. 6, 2025

(54) LIQUID EJECTION HEAD

(71) Applicant: CANON KABUSHIKI KAISHA, Tokyo (JP)

(72) Inventors: YOSHIYUKI FUKUMOTO, Kanagawa (JP); MASAYA UYAMA, Kanagawa (JP)

(21) Appl. No.: 18/819,665

(22) Filed: Aug. 29, 2024

(30) Foreign Application Priority Data
Aug. 31, 2023 (JP) 2023-141654

(51) Int. Cl. B41J 2/14

(52) U.S. Cl. CPC B41J 2/14; B41J 2002/14475; B41J 2002/14491

(57) ABSTRACT

A liquid ejection head with multiple ejection ports arrayed includes: a first substrate having energy generation elements in one surface and first supply ports passing through the first substrate from the one surface to the other surface; and a second substrate which is bonded to the first substrate in a stack direction with an adhesive and which includes second supply ports communicating with the first supply ports and passing through the second substrate from the bonded surface to the other surface. Each first supply port includes a first opening in the bonded surface. Each second supply port includes a second opening in the bonded surface. In at least one direction out of an array direction of the ejection ports and a direction orthogonal to the array direction, a width W₁ of the first opening and a width W₂ of the second opening satisfy W₁>W₂.

### BACKGROUND OF THE INVENTION

### Field of the Invention

The present disclosure relates to a liquid ejection head using a substrate assembly in which multiple substrates are bonded together.

### Description of the Related Art

Many micro electro mechanical systems (MEMS) devices are fabricated by bonding substrates together. An example thereof is a liquid ejection head to eject liquid.

An example of the liquid ejection head is an inkjet print head. The inkjet print head includes energy generation elements to provide energy for ink ejection. An ejection port forming member is formed on a surface of a substrate and ejection ports for ejecting the ink are opened in the ejection port forming member. Through holes are formed in the substrate and the ink is supplied through the through holes from the back side to the front side of the substrate. The through holes function as ink channels through which the inks flow.

As a method for producing an inkjet print head, an adhesive bonding technique is generally used in which substrates are bonded together using an adhesive such as resin. In bonding, the adhesive is squeezed and moves into the channels as an excess adhesive. Such excess adhesive may block the ink channels. Blocking the ink channels is problematic because it causes an ejection failure by stopping an ink flow passage.

Japanese Patent Laid-Open No. 2004-249668 (hereinafter referred to as Patent Literature 1) proposes that, in bonding silicon substrates with ink channels processed therein to each other, slits, which are provided in bonded surfaces of partition walls each located between the liquid channels, are caused to absorb an excess adhesive and thereby reduce the amount of the excess adhesive.

### SUMMARY OF THE INVENTION

In the case where the slits are provided as in Patent Literature 1, there is a risk that the partition walls are broken during manufacturing processing because the strength of the partition walls is decreased. In addition, the necessity to reserve spaces for providing the slits in the partition walls makes it difficult to reduce the width of the partition walls, which also leads to difficulties in improving the performance by arranging pressure chambers at a higher density and in lowering the cost by reducing the chip size.

One example of the present disclosure is a liquid ejection head in which multiple ejection ports are arrayed, the liquid ejection head including: a first substrate having an energy generation element in one of surfaces and first supply ports passing through the first substrate from the one surface to a first bonded surface which is the other surface; and a second substrate which is bonded at a second bonded surface to the first bonded surface of the first substrate in a stack direction with an adhesive interposed in between, and which has second supply ports communicating with the first supply ports, the second supply ports passing through the second substrate from the second bonded surface to the other surface of the second substrate. Each of the first supply ports has a first portion including a first opening formed in the first bonded surface and a third portion including a third opening formed on a side including the energy generation element in the first substrate, an opening area of the third opening being smaller than an opening area of the first opening. In the first portion, a lateral side and an upper side which is a portion connected to the third portion intersect and form an obtuse angle. Each of the second supply ports has a second opening in the second bonded surface. In at least one direction out of an array direction of the ejection ports and a direction orthogonal to the array direction, a width W₁ of the first opening and a width W₂ of the second opening satisfy W₁>W₂.

Further features of the present invention will become apparent from the following description of exemplary embodiments with reference to the attached drawings.

### BRIEF DESCRIPTION OF THE DRAWINGS

FIGS. 1A-1 to 1E are cross-sectional views illustrating a method for producing a liquid ejection head in a first embodiment of the present disclosure;

FIGS. 2A and 2B are plan views each illustrating a positional relationship between openings at bonded portions;

FIGS. 3A to 3C are cross-sectional views illustrating the first embodiment and comparative examples;

FIGS. 4A and 4B are cross-sectional views each illustrating a positional relationship of an adhesive moved;

FIGS. 5A to 5C are plan views each illustrating a positional relationship between openings at bonded portions;

FIGS. 6A to 6C are cross-sectional views each illustrating an adhesive in bonding;

FIGS. 7A to 7F are plan views each illustrating an example of a shape of a second opening;

FIGS. 8A-1 to 8E are cross-sectional views illustrating a method for producing a liquid ejection head in a second embodiment of the present disclosure;

FIGS. 9A-1 to 9B-2 are cross-sectional views illustrating a modification of a method for producing a first substrate in the second embodiment of the present disclosure;

FIGS. 10A and 10B are cross-sectional views illustrating processing examples of the first supply ports in the second embodiment of the present disclosure;

FIGS. 10C and 10D are bird's-eye views of a region C in the second embodiment of the present disclosure;

FIGS. 11A to 11C are cross-sectional views illustrating an example of a method for producing first supply ports and third supply ports in the second embodiment of the present disclosure;

FIG. 12 is a bird's eye view of an example of the liquid ejection head produced in the second embodiment of the present disclosure;

FIG. 13A is a plan view of an example of a liquid ejection head in the present disclosure; and

FIG. 13B is a plan view of a second substrate boned to the liquid ejection head in the present disclosure.

### DESCRIPTION OF THE EMBODIMENTS

Hereinafter, examples of embodiments of the present disclosure will be described by using the drawings. It should be noted that the following description is not intended to limit the scope of the present disclosure. Although the present embodiments employ a thermal system that ejects inks by generating air bubbles with heater elements as an example, the present disclosure may be also applied to liquid ejection heads employing a piezo system and other various liquid ejection systems.

In the present disclosure, an X axis, a Y axis, and a Z axis are used as appropriate as directional axes for explaining the structure and so on of the liquid ejection head. The X axis and the Y axis are orthogonal to each other on a horizontal plane and constitute a liquid ejection plane. A longitudinal axis of the liquid ejection head extends in a Y axis direction (Y direction) and a print medium is moved in an X axis direction (X direction). The Z axis is a vertical axis orthogonal to the X axis and the Y axis, and a Z axis direction (Z direction) is a direction in which a first substrate 131 and a second substrate 132 are stacked as will be described later.

### First Embodiment

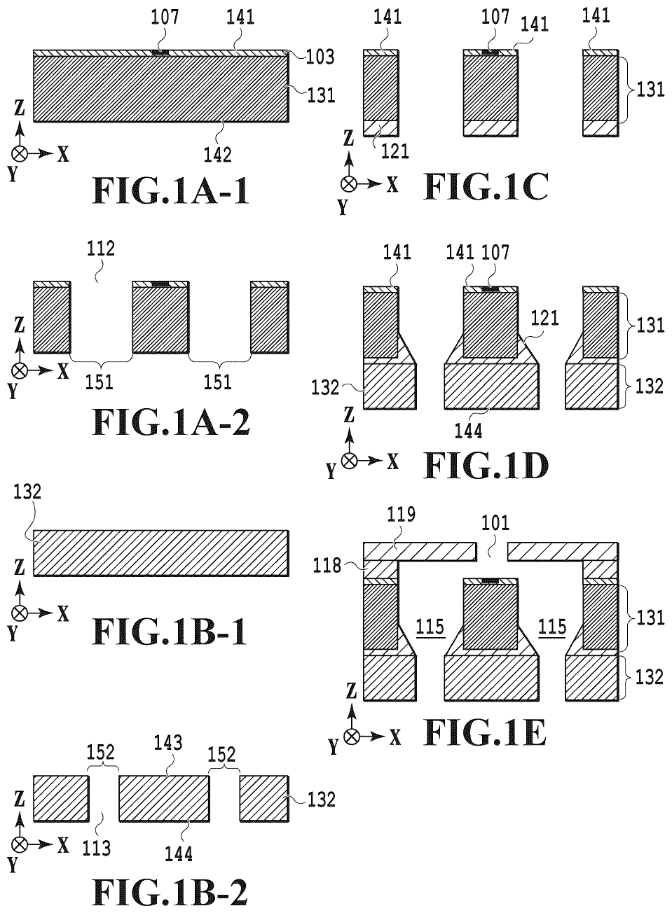

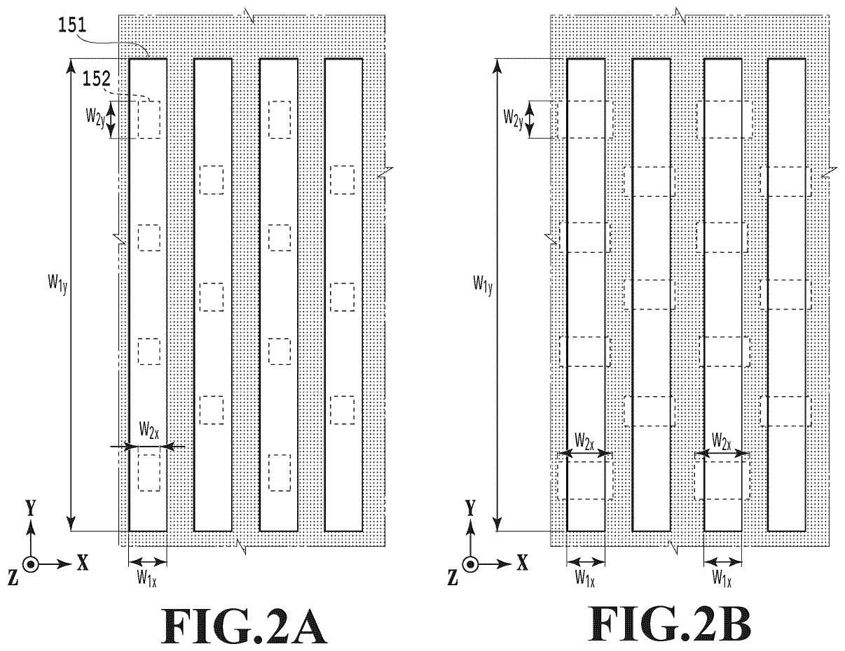

FIGS. 1A-1 to 1E illustrate cross-sectional views of a method for producing a liquid ejection head according to the present embodiment. FIGS. 1A-1 and 1A-2 illustrate a method for processing the first substrate 131. The first substrate 131 in which circuits and energy generation elements (for example, heaters) 107 are formed in a first surface 141 is prepared (FIG. 1A-1). A second surface 142 of the first substrate 131 located opposite to the first surface 141 serves as a bonded surface to be bonded to the second substrate 132 as will be described later.

Silicon is preferably used for the first substrate 131. This is because semiconductor elements such as transistors constituting the circuits have to be formed in the first substrate 131. The second surface 142 (back surface) of the first substrate 131 is processed to thinning the first substrate 131 to a desired thickness. If not necessary, the substrate thinning processing may be omitted. Next, the second surface 142 of the first substrate 131 is smoothed. The smoothing is performed by polishing such as grinding, dry polishing, or chemical mechanical polishing (CMP).

Next, as illustrated in FIG. 1A-2, first supply ports 112 are processed in the first substrate 131. In the present embodiment, the first supply ports 112 are opened as through holes passing through the first substrate 131 to the second surface 142. An opening of each first supply port 112 in the second surface 142 is defined as a first opening 151. A circumferential length of the above opening is defined as a circumferential length of the first opening 151. A shape of the first supply port 112 is, for example, a groove shape extending in a longitudinal direction. Examples of the processing method include chemical dry etching, chemical wet etching, laser, sandblasting, and so on.

FIGS. 1B-1 and 1B-2 illustrate a method for processing the second substrate 132. The second substrate 132 is prepared (FIG. 1B-1). For the second substrate 132, silicon or a resin material may be used, but a silicon substrate is preferred which has a higher strength than a resin material and is stable in a liquid. A surface of the second substrate 132 to serve as a bonded surface is referred to as a third surface 143 and the opposite surface is referred to as a fourth surface 144.

In the second substrate 132, second supply ports 113 are processed (FIG. 1B-2). The processing method is the same as the method for processing the first supply ports 112. The second supply ports 113 include a large number of through holes which pass through the second substrate 132 from the third surface 143 to the fourth surface 144 and are smaller than the first supply ports 112.

An opening of each second supply port 113 formed in the third surface 143 is defined as a second opening 152. A circumferential length of the above opening is defined as a circumferential length of the second opening 152.

FIGS. 1C to 1E illustrate assembling work for the liquid ejection head including the first substrate 131 and the second substrate 132. An adhesive 121 is provided on the second surface 142 of the first substrate 131 (FIG. 1C). For the adhesive 121, a material with high adhesion to the substrates is recommended. A material with few air bubbles and the like included therein is preferred from the viewpoint of application quality, or a material with low viscosity with which the adhesive 121 can be easily applied thinly is preferred. As the material, there are an epoxy resin, an acrylic resin, a silicone resin, a benzocyclobutene resin, a polyamide resin, a polyimide resin, and a urethane resin.

The first substrate 131 on which the adhesive 121 is applied and the second substrate 132 are aligned by an alignment device with the second substrate 132 placed under the first substrate 131 in the direction of gravity. Next, the stacked substrates thus aligned are clamped and preliminarily fixed by a clamping mechanism or the like. The preliminarily-fixed stacked substrates are transferred to a bonding apparatus. In the bonding apparatus, the stacked substrates are heated to a predetermined temperature and then bonded together by being pressed with a predetermined pressure for a predetermined time. These bonding parameters are set as appropriate depending on the adhesive material. In addition, it is preferable to perform the bonding in a vacuum in order to prevent air bubbles from entering the bonded portions.

In the case where the adhesive 121 is of a thermosetting type, the substrates may be heated in the bonding apparatus until the adhesive is cured. Instead, the substrate assembly may be taken out after bonding and then be heated in another oven or the like to cure the adhesive.

After the adhesive is completely cured, the first supply ports 112 and the second supply ports 113 communicate with each other to form channels 115 which pass through the substrate assembly (FIG. 1D). In the present embodiment, multiple second supply ports 113 communicate with one first supply port 112. The circumferential length of the first opening 151 is longer than the circumferential length of the second opening 152.

FIG. 2A illustrates a plan view in which a preferred positional relationship between the first openings 151 and the second openings 152 is drawn. FIG. 2A illustrates the first openings 151 and the second openings 152 in the case where the substrate assembly in FIG. 1D is viewed from the first surface 141 side.

In the present embodiment, multiple second openings 152 are arrayed in the longitudinal direction (Y direction) of each first opening 151. The circumferential length of the second opening 152 is shorter than the circumferential length of the first opening 151. The length of the first opening 151 in a short-side direction (X direction) is denoted by W_{1X} and the length of the second opening 152 in the short-side direction (X direction) is denoted by W_{2X}. Similarly, the length of the first opening 151 in the longitudinal direction (Y direction) is denoted by W_{1Y} and the length of the second opening 152 in the longitudinal direction (Y direction) is denoted by W_{2Y}.

In FIG. 2A, W_{1X}>W_{2X} holds in the short-side direction and W_{1Y}>W_{2Y} is satisfied also in the longitudinal direction. The present embodiment is preferable because the width W₁ of the first opening 151 and the width W₂ of the second opening 152 satisfy the relationship W₁>W₂ not only in the X direction and the Y direction but also in any direction around 360°. As will be described later, in the case of such a structure, the adhesive runs up toward the first supply ports 112 (in the Z direction) as illustrated in FIG. 1D.

Next, an ejection port forming member is formed on the first surface 141 side of the substrate assembly. A dry film resist in which a film base material is coated with a photocurable resin is bonded to the first surface 141 of the substrate assembly. After that, walls 118 of the ejection port forming member are patterned by light exposure and development. Subsequently, a top plate 119 of an ejection port forming member is formed on the walls 118 in a similar method. For example, a dry film resist is bonded to the walls 118 and then is exposed to light and developed, so that the top plate 119 having ejection ports 101 is formed and thus the liquid ejection head is completed (FIG. 1E).

In the present embodiment, the first substrate 131 is a substrate including the energy generation elements 107, the ejection port forming members 118 and 119 having the ejection ports 101, and driver ICs in the first surface 141. Thus, the first supply ports 112 have a function for supplying the liquid to the energy generation elements 107. The liquid heated by the energy generation elements 107 is ejected from the ejection ports 101. The first substrate 131 can function as a liquid ejection head substrate.

In the embodiment illustrated in FIG. 2A, the first supply port 112 has a large groove shape and extends in the longitudinal direction (Y direction). In order to increase the speed of liquid supply to the multiple ejection ports and heater elements present in the first surface 141, the volume of the first supply port 112 is preferably large.

The second substrate 132 includes the second supply ports 113 and has a function to converge the liquid channel of each first supply port 112 in a planar direction and connect the first supply ports 112 to fourth supply ports formed in a base member located under the fourth surface 144 of the second substrate 132. The width and the adjacent supply port pitch of the fourth supply ports are wider than those of the first supply ports 112.

As illustrated in FIG. 2A, multiple second supply ports 113 communicate with the inside of the first opening 151 of each first supply port 112. Each second supply port 113 is a through hole having a smaller volume than that of the first supply port 112, and the circumferential length of the second opening 152 is also shorter than the circumferential length of the first opening 151. A cross section of the second openings 152 in the substrate assembly is as illustrated in FIG. 1E. The second substrate 132 functions as a member that changes the pitch between the liquid supply ports for the first substrate 131 (liquid ejection head substrate).

FIG. 2B illustrates a substrate assembly in a modification of the present embodiment in which the width W₁ of the first opening 151 and the width W₂ of the second opening 152 has the relationship W₁<W₂ in one direction. As similar to FIG. 2A, multiple small through holes of the second supply ports 113 communicate with each large groove-shaped first supply port 112.

However, in the present modification, there is a direction in which the circumferential length of the first opening is shorter than the circumferential length of the second opening. In the present modification, W_{1y}>W_{2y} holds in the longitudinal direction (Y direction), but W_{1X}<W_{2X} holds in the short side direction (X direction). Therefore, the adhesive pushed out from the bonded portions in the short side direction may act disadvantageously in some cases as will be described later.

The second supply ports 113 collect the liquid from the large groove-shaped first supply port 112 and connect the first supply port 112 to one of the multiple fourth supply ports (not illustrated) located under FIG. 1E. Each of the multiple second supply ports 113 may be selectively connected to any of the multiple fourth supply ports.

For example, each second supply port 113 may connect the supply ports upstream or downstream of the ejection ports in liquid circulation, or may connect the supply ports for the same color in the case where different kinds of inks are used. Since the second supply port 113 is small, the second supply port 113 can connect a desired pair of the first supply ports and the fourth supply ports separately from the other supply ports. Therefore, there is a problem that the second opening 152 tends to have a short circumferential length and be blocked with the adhesive.

For this reason, making it difficult for the adhesive 121 to move to the second supply ports 113 is effective for preventing the blockage. On the other hand, an excess adhesive as a result of moving with bonding is generated around the bonded portions. In the present embodiment, a movement of the excess adhesive is controlled depending on a positional relationship between the openings of the first supply ports 112 and the openings of the second supply ports 113 makes it possible, so that it becomes possible to make it difficult for the excess adhesive to move to the second supply ports 113.

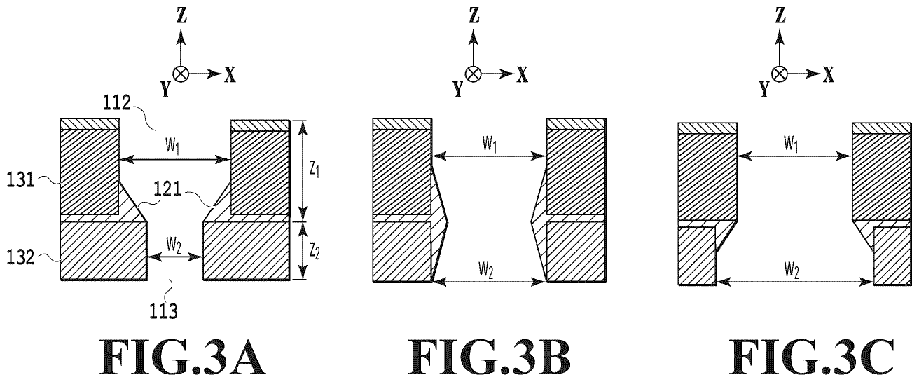

FIGS. 3A to 3C each illustrate a relationship between conceivable positions of the openings and a conceivable movement of the adhesive 121. FIGS. 3A to 3C illustrate different cases depending on a size relationship between the width W₁ of the first opening 151 and the width W₂ of the second opening 152.

FIG. 3A illustrates the case where W₁>W₂, in which the adhesive 121 is pushed out from between the bonded surfaces and runs up toward the first supply port 112 (+Z direction). FIG. 3B illustrates the case where W₁=W₂, in which the adhesive 121 moved from the lateral sides of the bonded surfaces runs up the lateral side of the first supply port 112 and down the lateral side of the second supply port 113.

FIG. 3C illustrates the case where W₁<W₂. In this case, the adhesive 121 reaching the first opening 151 stops moving in the horizontal direction due to a surface tension. Then, the adhesive 121 runs down toward the lateral side of the second supply port 113 (−Z direction).

FIGS. 3B and 3C are comparative examples in which the adhesive 121 rune down toward the second supply port 113 (in the −Z direction) and therefore may block the second supply port 113. In contrast, FIG. 3A is an example where W₁>W₂, in which the adhesive 121 reaching the second opening 152 stops moving in the horizontal direction due to the surface tension and runs up the lateral side of the first supply port 112. In this case, the adhesive 121 is less likely to enter the second supply port 113, which is favorable as an embodiment of the present disclosure.

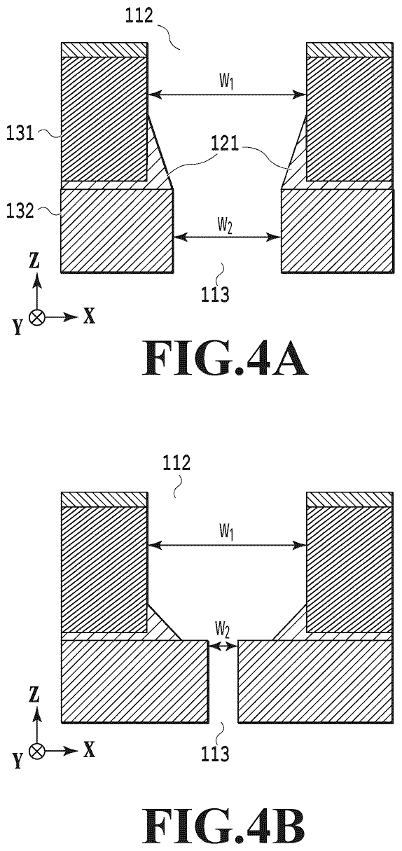

A more preferable example in the case where W₁>W₂ is satisfied will be described. FIGS. 4A and 4B are cross-sectional views of the bonded portions of the first substrate 131 and the second substrate 132 with the adhesive cured. From the viewpoint of adhesion strength, the case where the adhesive 121 reaches the second opening 152 as illustrated in FIG. 4A is more preferable than the case where the adhesive 121 does not reach the second opening 152 as illustrated in FIG. 4B.

This is because, after the adhesive 121 reaches the opening, the excess adhesive runs up the lateral side of the first supply port 112 due to the surface tension. The adhesive 121 running up the lateral side of the first supply port spreads more widely and thinly than in the case of FIG. 4B. Thus, as compared with the case where the adhesive 121 does not run up (FIG. 4B), the contact area of the adhesive 121 with the first substrate 131 is increased and the adhesion strength is enhanced.

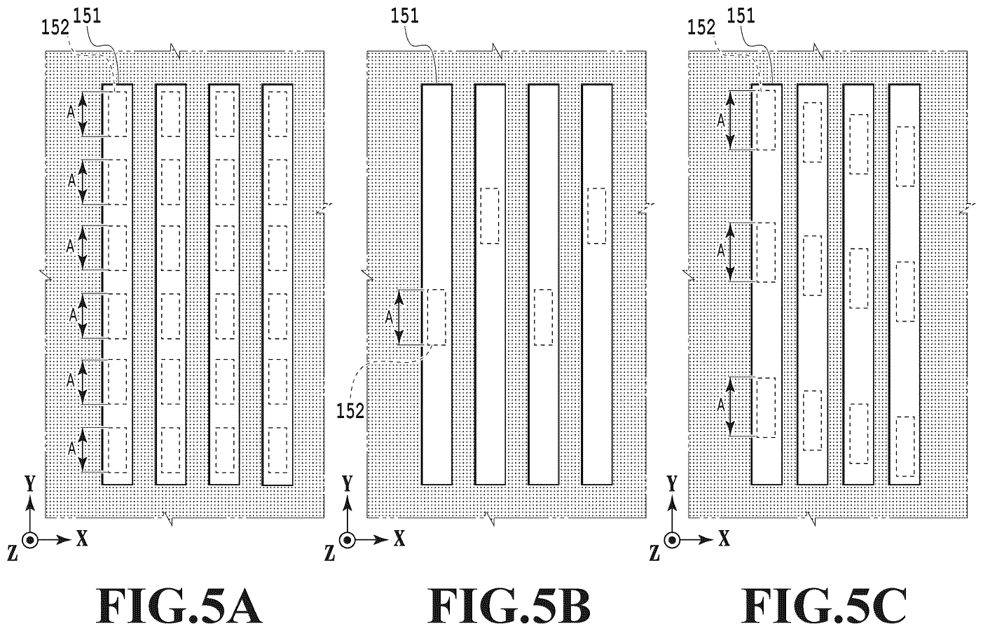

From the viewpoint of such adhesion strength enhancement, the larger the number of the second supply ports 113, the more preferable. FIGS. 5A to 5C illustrate arrangement examples of the first openings 151 and the second openings 152. In FIG. 5B, only one second supply port 113 communicates with each of the first supply ports 112. In comparison with this case, it is preferable to arrange a large number of second supply ports 113 as illustrated in FIG. 5A. This is because, as the total sum of the lengths A of portions around the second openings 152 in contact with the adhesive 121 increases, the area of the adhesive 121 running up the lateral sides of the first supply ports 112 increases proportionally.

In addition, it is also preferable to arrange the second supply ports 113 (that is, the second openings 152) evenly over the entire first supply port 112 (that is, the first opening 151) in the longitudinal direction because the entire first supply port 112 can be bonded evenly. For example, the second openings 152 arranged around both ends of the first opening 151 and around the center of the first opening 151 as illustrated in FIG. 5C can enhance the adhesion strength at the entire first supply port 112. For this reason, it is preferable to arrange three or more second supply ports 113 for each first supply port 112.

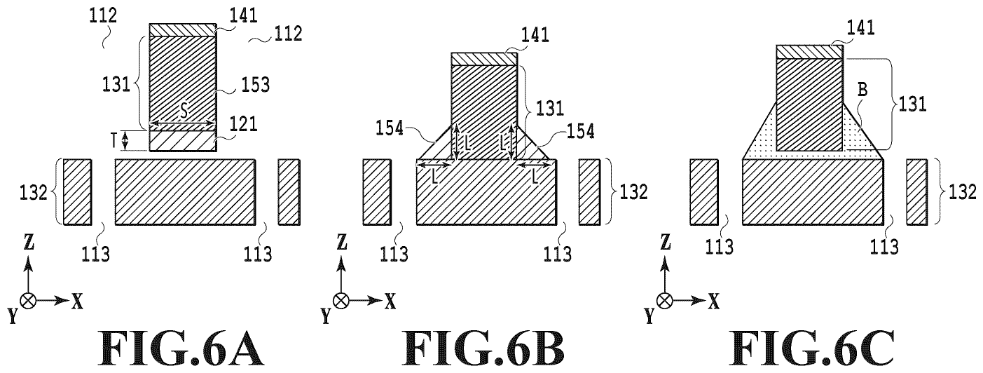

A condition that allows the adhesive 121 to reach the second openings 152 will be described. FIG. 6A illustrates a cross-sectional view before bonding in which the adhesive 121 is applied to the second surface at a partition wall 153 of the first substrate 131. An adhesive volume V per unit length in a depth direction (Y direction) corresponds to the area of the adhesive 121 in FIG. 6A.

In the case where the adhesive 121 is squeezed and moves after bonding, the adhesive 121 moves by equal distances in the X direction and the Z direction from the bonded portions due to a surface tension and forms adhesive pools 154 illustrated as isosceles triangular cross sections on both sides of the partition wall 153. If all the adhesive 121 moves as illustrated in FIG. 6B, a width L of the adhesive pool 154 is expressed by Formula (1) using the adhesive volume V as presented below.

$${L}^{2} = V \qquad ( 1 )$$

In order for the adhesive 121 to run over the second substrate 132 and reach the second opening 152, it is at least necessary that a distance d from the end of the first opening 151 (the end of the partition wall) to the end of the second opening 152 be equal to or smaller than L. Accordingly, as the condition that allows the adhesive 121 to reach the second opening 152, Formula (2) presented below has to be satisfied.

$$d \leq {( V )}^{0.5} \qquad ( 2 )$$

For example, in the case where the adhesive volume V is simply expressed by an adhesive thickness T×a partition wall width S as illustrated in FIG. 6A, Formula (2) is transformed to Formula (3).

$$d \leq {( T \times S )}^{0.5} \qquad ( 3 )$$

In the case where the first opening and the second opening are concentrically located, Formula (3) is transformed to Formula (4).

$${W}_{1} - {W}_{2} \leq 2 \times {( T \times S )}^{0.5} \qquad ( 4 )$$

Therefore, in order for the adhesive 121 to reach the second opening 152, the distance d from the end of the second opening 152 to the end of the first opening 151 has to be set to be equal to or smaller than the distance expressed by Formulas (2) to (4).

Moreover, the adhesive volume V can be measured from the bonded substrates. For example, in the case where the first supply ports 112 are arrayed in the short side direction (X direction), a cross section at the bonded portions is exposed in the short side direction and observed. In the cross section observed around the partition wall 153 between the first supply ports 112, the area of the adhesive portion corresponds to the adhesive volume V.

FIG. 6C illustrates a typical example of the cross section. The adhesive is squeezed, so that some portion of the adhesive remains on the bonded surfaces and the other portion moves to both sides of the partition wall 153. The shape of the adhesive 121 initially present on the partition wall 153 is changed to a shape of a dotted region B. Therefore, the area of the dotted region B corresponds to the adhesive volume V after bonding. The methods for exposing the cross section include various dicing methods, FIB, CMP, and so on. The observation methods include SEM and TEM.

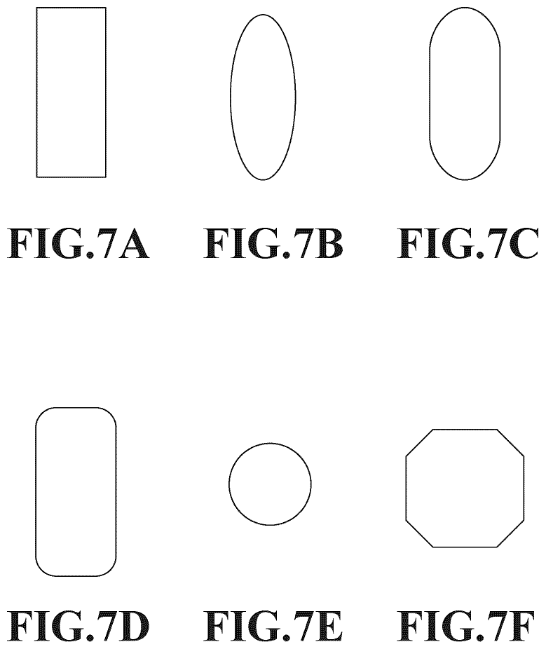

Preferred shapes of the second supply port 113 will be described. FIGS. 7A to 7F illustrate plan views of the second openings present in the third surface. FIG. 7A illustrates a rectangular shape that is a typical shape. In the rectangular shape as in FIG. 7A, however, capillary force from the four vertices (corners) to the inside of the second supply port 113 are more likely to act and help the adhesive 121 to run into the second supply port 113.

To address this, as illustrated in FIGS. 7B, 7C, 7D, and 7E, a shape without having corners with vertices is formed by replacing the corners with arcs. In such a shape, the capillary force is less likely to act on the adhesive 121, and therefore the adhesive 121 is less likely to enter the inside of the second supply port 113.

FIG. 7B illustrates an ellipse shape and FIG. 7C illustrates an oval shape composed of semicircles and a rectangle. FIG. 7D illustrates a rectangular shape with only the corners replaced with arcs and FIG. 7E illustrates a circular shape. In addition, an octagonal shape as in FIG. 7F is also preferred, because each vertex has a larger angle than in a rectangular shape, so that the capillary force is weakened and the adhesive 121 is less likely to enter the inside of the second supply port 113 than in the case of FIG. 7A. Instead of the octagonal shape, any polygonal shape having 5 or more sides with obtuse vertices can more effectively prevent the adhesive from entering the second supply port 113 than in FIG. 7A. Thus, the prevention of the movement of the adhesive 121 to the second supply port 113 as described above helps the adhesive 121 to run up the lateral side of the first supply port 112.

Moreover, it is preferable that a depth Z₁ of the first supply port 112 illustrated in FIG. 3A is as great as possible. This is because a large amount of the adhesive 121 can be retained on the lateral side of the first supply port 112. It is preferable to design the liquid ejection head such that the depth Z₁ of the first supply port 112 is greater than at least a depth Z₂ of the second supply port 113. In particular, in a case where the total thickness of the bonded substrates is fixed, it is desirable to make the first supply port 112 as deep as possible.

### Second Embodiment

In the case where the adhesive 121 runs up the lateral sides of the first supply ports 112 as described in the first embodiment, there is a risk depending on the amount of the adhesive 121 that the adhesive 121 reaches the first surface 141 and further reaches the energy generation elements present in the first surface 141 to deteriorate the ejection performance.

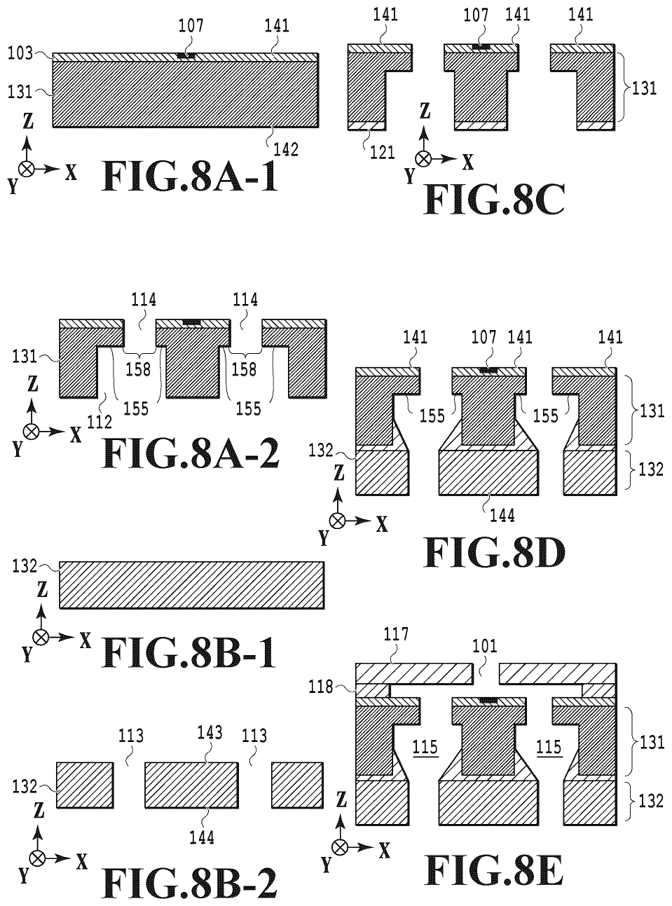

To address this, in the present embodiment, an example where the first supply port 112 is formed in an overhang shape will be described. FIGS. 8A to 8E illustrate cross-sectional views of a method for producing a liquid ejection head according to the present embodiment.

FIGS. 8A-1 and 8A-2 illustrate a method for processing the first substrate 131. The first substrate 131 in which the circuits and the energy generation elements (for example, the heaters) 107 are formed in the first surface 141 is prepared (FIG. 8A-1), and supply ports are processed in the first substrate 131. In this step, the first supply ports 112 combined with third supply ports 114 as illustrated in FIG. 8A-2 are formed in place of the first supply ports 112 described in the first embodiment.

The first supply ports 112 are processed from the second surface 142 to a middle of the first substrate 131, and the third supply ports 114 communicate with the sides (upper side) of the first supply ports 112 opposite to the second surface 142. An opening formed on the upper side of each first supply port 112 is defined as a third opening 158. A width of the third supply port 114 in the X direction is narrower than that of the first supply port 112 (in other words, the opening area of the third opening 158 is smaller than the opening area of the first opening 151), so that the upper side of the first supply port 112 serves as an overhang portion 155.

After the first supply ports 112 are processed from the second surface 142 and this process is stopped in the middle of the first substrate 131, the third supply ports 114 may be then processed from the first surface 141 so as to communicate with the first supply ports 112. Instead, after the first supply ports 112 are formed, the narrow third supply ports 114 may be continuously processed so as to pass through the first substrate 131 to the first surface 141.

There are several possible methods for processing the first supply ports 112. These methods include chemical dry etching, chemical wet etching, laser, sandblasting, cutting, and the like.

After the processing on the first substrate 131 is completed, the second substrate 132 is processed to form the second supply ports 113 (FIGS. 8B-1 and 8B-2), and then is bonded to the first substrate 131 (FIGS. 8C and 8D) in the same manner as in the first embodiment. After the adhesive for bonding is cured, the ejection port forming members are formed on the first surface 141 to complete the liquid ejection head (FIG. 8E).

In the present embodiment, in the bonding step in FIG. 8D, the adhesive 121 that runs up the lateral sides of the first supply ports 112 can be stopped by the upper sides (the overhang portions 155) of the first supply ports 112. Since the adhesive 121 is stopped by the overhang portions 155, the adhesive 121 is less likely to reach the third supply ports 114 or the first surface 141 beyond the third supply ports 114, and thereby is prevented from deteriorating the energy generation elements 107 in the first surface 141.

In another mode of the method for forming the overhang portions 155, as illustrated in FIGS. 9A-1 to 9A-3, an SOI substrate may be used as the first substrate 131. In this case, the overhang portions 155 may be formed by processing the first supply ports 112 from the second surface 142 up to an oxide film 157 of the SOI substrate, then processing the third supply ports 114 from the first surface 141, and finally removing the oxide film 157.

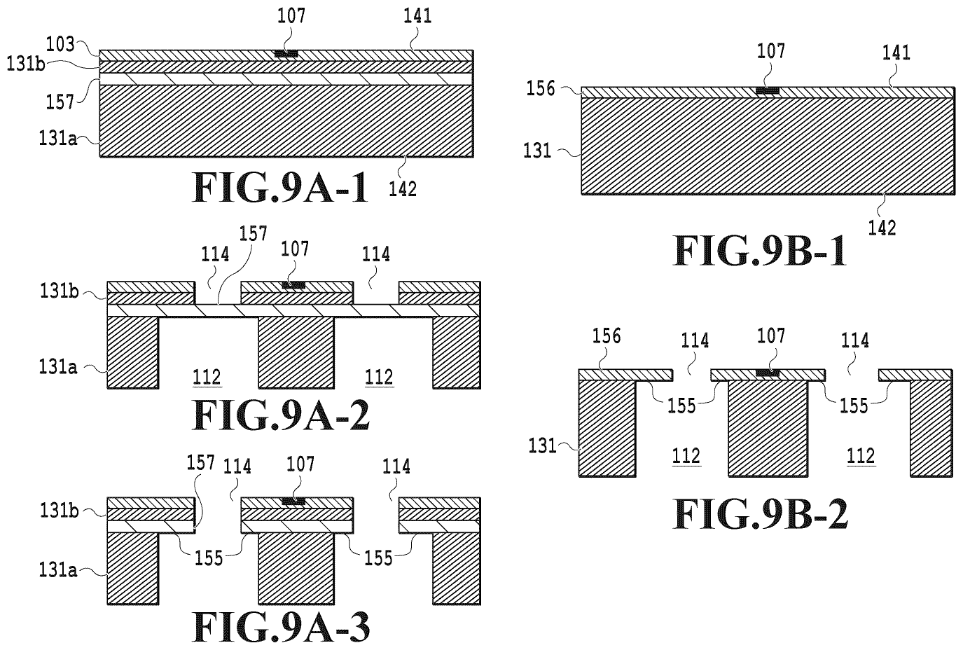

Instead, as illustrated in FIGS. 9B-1 and B-2, the overhang portions 155 may be formed by forming a membrane film 156 made of an oxide film, a resin film, or a multi-layer film of these films on the first surface 141 of the first substrate 131. For example, the overhang portions 155 may be formed by processing the first substrate 131 up to the membrane film 156, and then processing the third supply ports 114 in the membrane film 156. The membrane film 156 is set to have a film configuration that can maintain sufficient strength and rigidity even after the substrate portion supporting the membrane film 156 is removed.

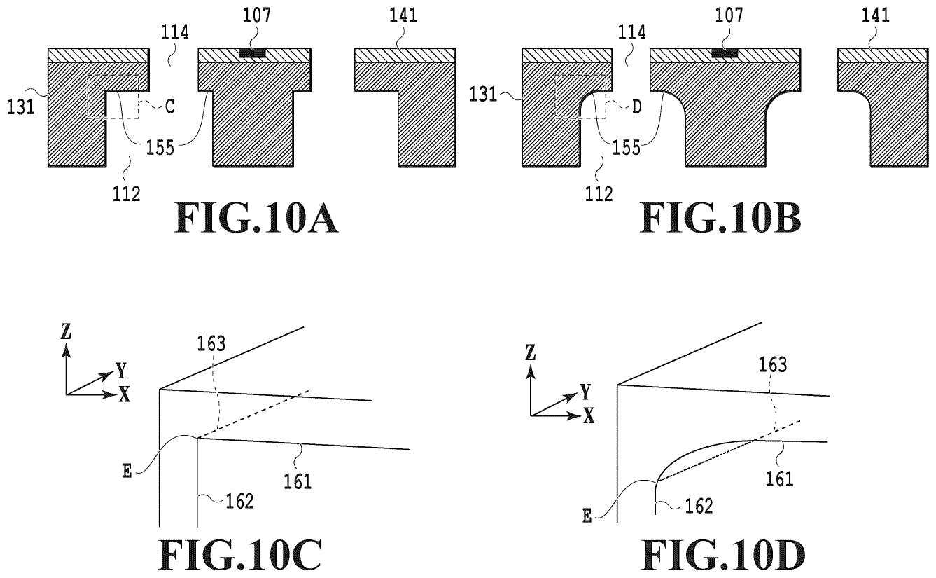

In a more preferable shape of the first supply port 112, an overhang surface to serve as the upper side of the first supply port 112 is curved. FIG. 10A illustrates a cross-sectional view of the first substrate 131 processed in a general production method. FIG. 10C illustrates a bird's-eye view of a region C (near the overhang portion 155) in the cross section of the first substrate 131 illustrated in FIG. 10A.

As illustrated in FIG. 10C, an overhang surface 161 is ideally processed to a flat surface, but the overhang surface 161 in the case of the flat surface forms the right angle with the other side of the first supply port 112. In FIG. 10C, the other side is a first supply port lateral surface 162, and there is an edge line 163 at which the first supply port lateral surface 162 intersects the overhang surface 161. The edge line 163 extends in the Y direction (supply port longitudinal direction). The angle formed between the above two surfaces forming the edge line is the right angle (the angle at a point E in FIG. 10C).

In the case of the edge line having the right-angled cross section, if the adhesive 121 runs up to the edge line 163, the adhesive 121 tends to move along the edge line 163 due to capillary force. The adhesive 121 tends to gather at the edge line 163 and spread over the entire edge line 163.

If a large amount of the adhesive 121 gathers at the edge line 163, the adhesive 121 also moves onto the overhang surface 161 existing in the X direction, and eventually reaches the third supply port 114. This may result in problems that the adhesive blocks the third supply ports and reaches the first surface 141 by running up the lateral sides of the third supply ports.

To address this, it is preferable that the overhang portion 155 be processed to be curved as illustrated in FIG. 10B. FIG. 10D illustrates a bird's-eye view of a region D in FIG. 10B. The overhang surface 161 is curved such that an end portion thereof is closer to the second surface 142 than a center portion thereof is.

As a result, the overhang surface 161 and the first supply port lateral surface 162 form an obtuse angle at their intersection. Moreover, since the overhang surface 161 is curved and connected to the first supply port lateral surface 162, there is no corner at their connection point (a point E in FIG. 10D). Consequently, in FIG. 10D, the adhesive 121 disperses due to a difficulty in moving along the edge line 163 due to capillary force, and is less likely to reach the third supply ports 114.

An effective production method for curving the overhang surfaces at the bottoms of the first supply ports 112 is to form the first supply ports 112 by processing with silicon dry etching and stopping the etching in the middle of the silicon substrate.

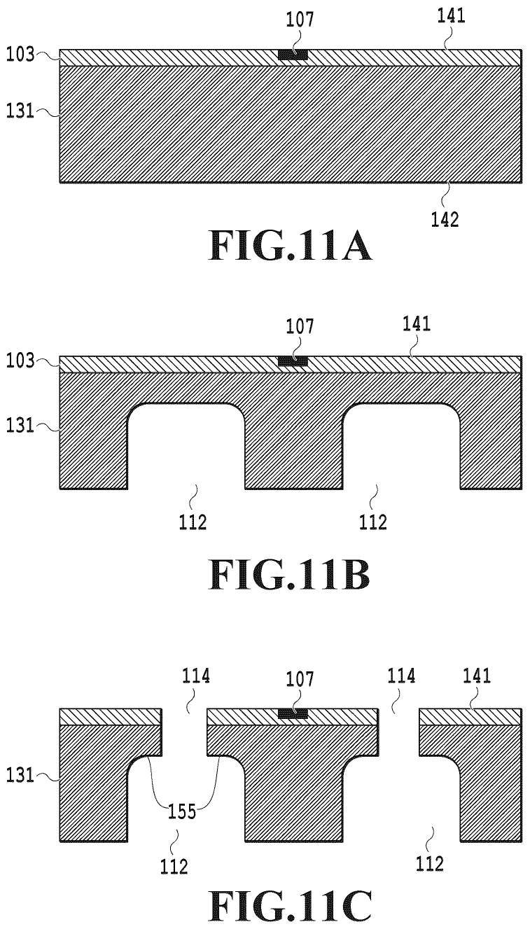

FIGS. 11A to 11C illustrate production flow diagrams thereof. The first substrate 131 in which the circuits and the energy generation elements (for example, the heaters) 107 are formed in the first surface 141 is prepared (FIG. 11A). In FIG. 11B, the first supply ports 112 are processed by dry etching from the second surface 142 of the first substrate 131, and the etching is stopped in the middle of the substrate. After that, the third supply ports 114 are processed (FIG. 11C). The third supply ports 114 may be processed in any method.

In the processing in FIG. 11B, the silicon substrate is etched by the dry etching using an etchant gas in which SF₆, Cl₂, CF₄, or the like is radicalized or ionized. Since the density of the etchant gas becomes high at the center of the first supply port 112, the overhang surface 161 tends to be deep at the center portion and shallow at the outer peripheral portions. As a result, as illustrated in FIGS. 11B and 11C, the overhang surface 161 can be curved.

Even with the dry etching, the overhang portion 155 is not curved if the overhang portion 155 serves as an etching stop layer as illustrated in FIGS. 9A and 9B. In addition, if the processing in FIG. 11B uses another method, namely, wet etching, the etchant molecules evenly enter the first supply port 112 and the overhang portion 155 is also less likely to be curved.

Preferably, the third opening 158 has a shape that makes it difficult for the adhesive 121 to enter the third opening 158 in the case where the adhesive 121 runs up the overhang portion 155. Having any of the preferable shapes for the second opening 152, the third opening 158 can prevent the adhesive 121 from entering the third opening 158. Specifically, the shapes in FIGS. 7B to 7F are preferable.

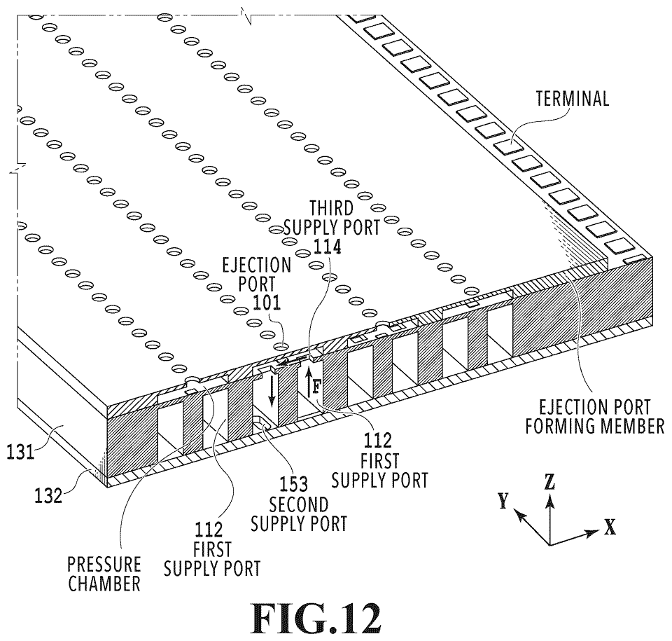

FIG. 12 illustrates a bird's eye view of an example of a liquid ejection head produced in the present embodiment. The first substrate 131 functions as a substrate that ejects the liquid. The second substrate 132 functions as a substrate that changes the pitch between the liquid supply ports.

The second substrate 132 allows the first supply ports 112 arrayed at a narrow pitch to communicate with the fourth supply ports (not illustrated) in the base member (located under the second substrate 132) via the minute second supply ports 113. Since the fourth supply ports are configured with a wider width or at a wider adjacent pitch than that of the first supply ports 112, the second substrate 132 makes the conversion from the narrow-pitched first supply ports 112 to the wide-pitched fourth supply ports.

The liquid is circulated along arrows designated with F in FIG. 12. The adjacent first supply ports function as a liquid inlet and a liquid outlet, respectively, and thereby prevent the liquid from sticking to the ejection ports 101 between the first supply ports. The circulating liquid moves to the fourth supply ports (not illustrated) through the second supply ports 113.

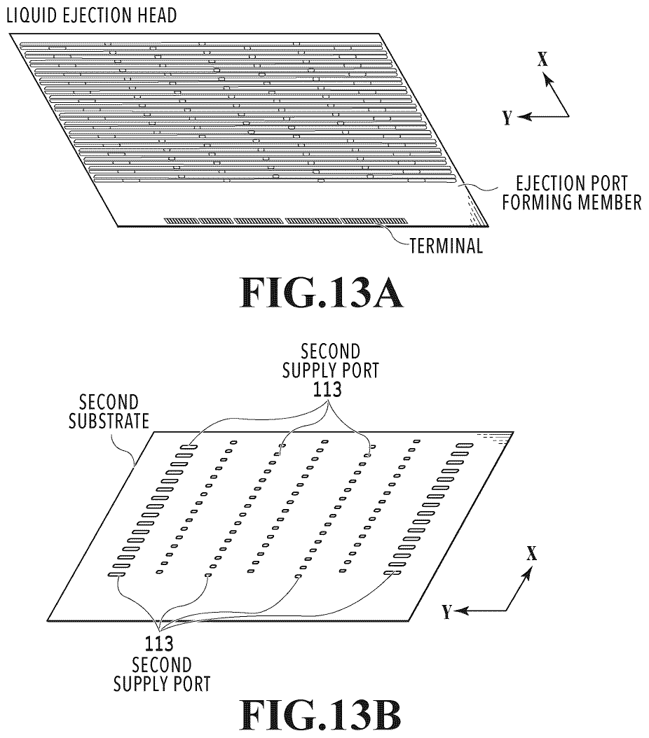

FIG. 13A illustrates a plan view of the liquid ejection head in FIG. 12 and FIG. 13B illustrates an example of a plan view of the second substrate 132. In the liquid ejection head, the multiple first supply ports 112 are arrayed and the second supply ports 113 are arrayed in the longitudinal direction of the first supply ports 112. As illustrated in FIG. 13B, the second opening 152 has an oval shape. Three or four second supply ports 113 communicate with each first supply port 112 and are arranged approximately evenly at the center and ends of the first supply port 112. Then, the width W₁ of the first supply port 112 and the width W₂ of the second supply port 113 satisfy W₁>W₂.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefits of Japanese Patent Application No. 2023-141654, filed Aug. 31, 2023, which is hereby incorporated by reference wherein in its entirety.

What is claimed is:

1. A liquid ejection head in which a plurality of ejection ports are arrayed, the liquid ejection head including:
a first substrate having an energy generation element in one of surfaces and first supply ports passing through the first substrate from the one surface to a first bonded surface which is the other surface; and
a second substrate which is bonded at a second bonded surface to the first bonded surface of the first substrate in a stack direction with an adhesive interposed in between, and which has second supply ports communicating with the first supply ports, the second supply ports passing through the second substrate from the second bonded surface to the other surface of the second substrate, wherein
each of the first supply ports has a first portion including a first opening formed in the first bonded surface and a third portion including a third opening formed on a side including the energy generation element in the first substrate, an opening area of the third opening being smaller than an opening area of the first opening,
in the first portion, a lateral side and an upper side which is a portion connected to the third portion intersect and form an obtuse angle,
each of the second supply ports has a second opening in the second bonded surface, and
in at least one direction out of an array direction of the ejection ports and a direction orthogonal to the array direction, a width W₁ of the first opening and a width W₂ of the second opening satisfy W₁>W₂.

2. The liquid ejection head according to claim 1, wherein an ejection port forming member having the ejection ports is provided on the surface of the first substrate including the energy generation element.

3. The liquid ejection head according to claim 1, further including a base member including fourth supply ports with a wider width or at wider adjacent pitch than that of the first supply ports, wherein
the base member is bonded to the second substrate, and
the second substrate allows the first supply ports to communicate with the fourth supply port through the second supply ports.

4. The liquid ejection head according to claim 1, wherein
a pool of the adhesive is formed continuously from a bonded portion of the second substrate to the second opening, and
the pool of the adhesive is in contact with the second opening.

5. The liquid ejection head according to claim 1, wherein
the first supply ports each extend in the array direction of the ejection ports and are arrayed in the direction orthogonal to the array direction of the ejection ports with a partition wall interposed in between, and
d≤(V)^{0.5} is satisfied,
where V denotes a volume per unit length in the array direction of the ejection ports of the adhesive pressed by the partition wall in the bonding, and d notes a distance between the partition wall and the adjacent second opening.

6. The liquid ejection head according to claim 1, wherein
W₁ₓ>W₂ₓ and W_{1y}>W_{2y} are satisfied,
where W₁ₓ denotes a width of the first opening in the array direction of the ejection ports, W_{1y} denotes a width of the first opening in the direction orthogonal to the array direction of the ejection ports, W₂ₓ denotes a width of the second opening in the array direction of the ejection ports, and W_{2y} denotes a width of the second opening in the direction orthogonal to the array direction of the ejection ports.

7. The liquid ejection head according to claim 1, wherein a depth of the first supply port is greater than a depth of the second supply port.

8. The liquid ejection head according to claim 1, wherein in the first supply port, the opening area of the third opening is smaller than the opening area of the first opening.

9. The liquid ejection head according to claim 8, wherein
the first supply ports each extend in the array direction of the ejection ports and are arrayed in a direction orthogonal to the array direction of the ejection ports with a partition wall interposed in between, and
each of the first supply ports includes a curved portion between the third opening and the partition wall.

10. The liquid ejection head according to claim 1, wherein
a shape of the second opening is a shape partly including an arc or a polygonal shape each including five or more sides.

11. The liquid ejection head according to claim 1, wherein
a shape of the third opening is a shape partly including an arc or a polygonal shape each including five or more sides.

12. The liquid ejection head according to claim 1, wherein
the first supply ports each extend in the array direction of the ejection ports and are arrayed in a direction orthogonal to the array direction of the ejection ports with a partition wall interposed in between, and
for each of the first supply ports, three or more of the second supply ports are arrayed along the array direction of the ejection ports.
